(19) United States
(12) Patent Application Publication
(10) Pub. No.: US 2015/0237028 A1
(43) Pub. Date: Aug. 20, 2015

(54) OPERATING SYSTEM MONITORING AND PROTECTION METHOD UTILIZING A VARIABLE REQUEST STRING GENERATOR AND RECEIVER ALGORITHM

(71) Applicant: Jeffrey S. Gibson, Memphis, TN (US)

(72) Inventor: Jeffrey S. Gibson, Memphis, TN (US)

(21) Appl. No.: 14/490,669

(22) Filed: Sep. 18, 2014

Related U.S. Application Data
(63) Continuation-in-part of application No. 14/094,796, filed on Dec. 3, 2013.

(51) Int. Cl. H04L 29/06; G06F 21/31; G06Q 20/40; H04L 29/08

(52) U.S. Cl. CPC H04L 63/08; H04L 67/303; G06F 21/31; G06Q 20/4016

(57) ABSTRACT

A novel method of monitoring and protecting on-line computer access from intrusions (hackers, viruses, worms, etc.) through the through the implementation of a specific algorithm that permits continuous and direct communication with both the user computer's operating system and the accessed server (at multiple contact points) for verification purposes during any on-line access event. The overall system depends on a string variable algorithm method that accords a contact point identifications to and for all operating systems and servers monitored thereby in order to provide a four-level protection system to allow for instantaneous and reliable recognition and identification of all components within such transactions by initiating electronic communication between the server and the algorithm system, the algorithm system and the operating system, and, ultimately, the operating system and the server.

### CROSS-REFERENCE TO RELATED APPLICATION

This application is a Continuation-in-Part of U.S. Non-Provisional patent application Ser. No. 14/094,796, filed on Dec. 3, 2013, which itself claims priority to U.S. Provisional Patent Application 61/802,347, filed on Mar. 15, 2013. The teachings and disclosures thereof both applications are herein entirely incorporated by reference.

### FIELD OF THE INVENTION

The present invention pertains to a novel method of monitoring and protecting on-line computer access from intrusions (hackers, viruses, worms, etc.) through the through the implementation of a specific algorithm that permits continuous and direct communication with both the user computer's operating system and the accessed server (at multiple contact points) for verification purposes during any on-line access event. The overall system depends on a string variable algorithm method that accords a contact point identifications to and for all operating systems and servers monitored thereby in order to provide a four-level protection system to allow for instantaneous and reliable recognition and identification of all components within such transactions by initiating electronic communication between the server and the algorithm system, the algorithm system and the operating system, and, ultimately, the operating system and the server. Through a simple link between the digital communication platform set up by the variable string algorithm between the server's system and at least one operating system seeking access to such a server, and initiated to match the identity of at least one verification contact point to ensure the trustworthiness of such a request (whether it be a financial transaction, an on-line search, a digital download, or any other such broad class of activities) involving the subject operating system itself, such communications, which do not require any need to divulge personal or other information of the operating system, ensure such requests are properly between the desired server and operating system and that any intrusions are prevented otherwise. The ability to do so with substantially instantaneous, low-bandwidth communications provides a method that accords protection to all entities involved with minimal interruption for greater efficiencies, as well.

### BACKGROUND OF THE PRIOR ART

Cybersecurity has become one of the most difficult issues facing the world today. With so much information placed upon, search from, etc., as well as transactions, be they financially based or otherwise, not to mention the sheer volume of digitized forms provided on servers (a term intended to include any basic platform that provides on-line information or acts as a conduit for transactions and/or communication between on-line users, including the “cloud” as it is commonly referred to currently), it is not a stretch to state that most of the world's business and other activities are highly dependent on such on-line considerations. As such, and because so much information is transferred, stored, etc., on such servers worldwide, and the value such information (be it, again, financial, secret, identity-based, etc.) commands, there is a constant threat from hackers, viruses, phishing operations, and the like, to invade, misdirect, even trick, certain users to give up some information, whether voluntarily or otherwise. Thus, it remains imperative that protections provide the best defense to such damaging intrusions and illegal on-line activities.

Currently, the best operations include purchased anti-virus programs or “patches” supplied by certain server systems. Microsoft, for example, has for years providing updates in this manner to attempt to thwart certain on-line activities of this sort. Some servers, however, are now prone to invasions as such “patches” have been stopped for the time being. Thus, for-purchase programs provide the best defenses in this manner. Unfortunately, these programs can only block intrusions and notify if unauthorized activities have been uncovered. If a bad actor has already accessed a person's device (and thus operating system), or a financial account number, or has attached a virus to a search engine result, such programs may have limited capability to prevent further problems. In other words, if a person's phone is stolen or hacked, a bad actor may utilize that device with passwords, etc., to order and purchase items on-line without any means to prevent such an action short of reporting such a stolen device. If such a bad actor is quick to undertake such an activity, however, the resultant purchase may not be stopped. In such a scenario, the person, or the person's financial account servicer may be out a large sum. A person's identity may be stolen, as well, from such devices, whether taken or accessed remotely. To that end, there is little that can be done to thwart further actions by such a bad actor until the damage is done (a new credit card account is opened, for instance). Likewise, a virus may institute itself within a person's operating system (on his or her computerized device) and record and send personal information to unauthorized persons or devices as well. In any of these situations, the ability to properly monitor and prevent unauthorized usage of devices, cards, etc., as well as the continued potential for corrupted operating systems from communicating in unauthorized fashion on-line would be highly desirable. Unfortunately, the limited capability of “patches” and for-purchase anti-virus, etc., programs do not provide an overarching protocol for validation purposes beyond the aforementioned limited procedures.

Thus, there exists a distinct need for a multi-step validation procedure for reliability and safety in terms of on-line computer access operations. A protocol that accords operating system monitoring and protection continuously and consistently would thus be a significant step in the right direction in this manner. To date, however, the limited methods available for such a purpose do not rise to such a level.

There have been many attempts to prevent the illegal or fraudulent use of credit cards and/or debit cards in shopping malls, over the Internet, and at Automated Teller Machines (ATMs). These efforts include Personal Identification Numbers (PINs), the use of mother's maiden names (or other specific information) as a secret identification, and requiring credit/debit card holders to use additional ID cards such as a driver license. All attempts to use static information such as these are not completely secure, since such information can be easily learned or stolen and passed on to other users. Once the static identification number is learned, it may be used to make fraudulent debit/credit card purchases until the fraud is detected and the debit/credit card account is closed.

In addition to the PIN system mentioned above, the CVV (card verification and validation) number is an additional security system currently in place for purchases using a debit and/or credit card where the card is not physically present, such as for internet or telephone transactions. The CVV number may be alternatively called CVV2 or CID (card identification) or CCV (credit card verification or validation) by various debit/credit card companies. The CVV number is typically printed on the back of the subject card, as with MasterCard or VISA, but may be on the front of the card, as with American Express, as examples. This number typically includes three or four digits. Merchants are not allowed to store CVV numbers in their database with the account number, as a security measure, meaning that, in principle, at least, such numbers will not be disseminated if a merchant's database is compromised. Also, since the CVV number is not in the database, each transaction must be accompanied by a new request for the number from the cardholder. Nevertheless, since the CVV numbers are disclosed to the merchants, their employees, and anyone in the communications chain, they may easily be recorded and passed on in a fraudulent manner. Not to mention, in certain establishments, such as restaurants, the permissive grant, temporarily, of one's debit and/or credit card to a server or like employee for the purpose of payment at a specific financial transfer device location allows ample opportunity for a person to review and record all such necessary information to then utilize the card at a future date and time.

Alternatively, there are other nefarious operations that attempt to prod such account information from unsuspecting individuals. For example, phishing has become a standard manner of having unsophisticated persons actually provide their bank account information to unidentified on-line actors posing as a trustworthy institution or entity. In such an exercise, for example, an unexpected email or other communication may be sent to an individual indicating a problem or issue has arisen with his or her account. In order to remedy such a situation, the phishing site (a link, for instance, within an email) that appears affiliated with the individual's bank or like entity, will request verification of identity through the input of information such as the individual's name, account number, other protected information (such as a password, social security number, etc.), even addresses, as examples. Once such information is unwittingly shared, the bad actor can then access the individual's account(s) and electronically steal as many assets as desired, particularly since such an actor now has all the necessary verification information of the account holder him- or her-self.

Additionally, there are currently devices of relatively low cost that may be employed surreptitiously by a bad actor to read and/or swipe embedded information from a person's card or cards via the magnetic strips, chips, or other like card information storage devices present thereon. Such reader devices may be placed in card readers that are typically accessed by consumers for payment purposes, or even within ATMs. Furthermore, however, and far more sinister, are devices that may be utilized in such a secretive fashion as to “bump” against a person's pocket or handbag (or the like) and automatically read such embedded card information. The information is thus instantly transferred to the device from which the bad actor(s) may make a copy (or copies) thereof in a new card, allowing for implementation within the new card's own magnetic strip (or like storage device). In such a fashion, the bad actor(s) can access the account through such stolen information and without the need for any further verification (since the user in that instance, being the bad actor, has the card information in hand and the standard purchasing/transferring protocols followed today require nothing further for most retail establishments, at least, to accept such a presentation).

Even more interesting is the potential for a funds transfer system to be supplied within a person's on-line account (such as Google, Pay Pal, etc.) or permitted through access from a person's phone alone (such as Google Wallet, Google Money, and the like), which actually store and utilize the person's own underlying financial accounts (whether checking, savings, credit, debit, retirement, etc., in nature). If such an on-line account is hacked or the phone is stolen, the bad actor may easily access all the underlying financial accounts linked thereto to withdraw and/or use such funds, or even just utilize the on-line system itself to make purchases, transfers, etc., on demand. Password technology is currently used to protect such possible problems, but, as noted above, sophisticated bad actors can detect and/or discover such information (even through answering certain general questions, the answers to which may be easily understood or at least uncovered). As such, mere hacking or physical theft could lead to such financial account invasions. If the phone or on-line account user leaves an email or other account open on his or her computer or phone, then the bad actor's accomplishments in this manner are made that much easier. Furthermore, such a bad actor could also set up new accounts in this type of theft situation, particularly if certain background information (social security number, etc., for example) has also been absconded with, thereby allowing for further fraudulent activity in this manner, all through a hard-to-detect new unauthorized account.

Some banks and other card providers have a monitoring system in place to at least attempt to prevent suspicious activity. For instance, the utilization of a card in a foreign location, for a rather large purchase, or other like potentially unlikely situation, may trigger a financial institution to call or otherwise try to communicate directly with the card holder for verification purposes. If such a communication fails to reach the card holder, the transaction may be held pending a reliable response. However, if the number involved, for example, is picked up by the bad actor in such an instance (such as through a stolen phone or even if the person is at the card holder's own home), then the financial institution, despite attempts to prevent such a problematic occurrence, may be forced to pay for such a mistaken identity (regardless of the malfeasance involved). Even more troublesome is that such suspicious activities have been uncovered through the utilization of certain algorithms by the subject financial institution searching for anomalies in account use. Unfortunately, though, some criminals have developed (or have had developed) similar programs to emulate these anomaly-searching types of financial institutions' in order to predict such situations and thus to provide initial warnings of probable unacceptable account activity in relation to the financial institution operations. In this manner, these bad actors are provided with a means to avoid such questionable account transactions (whether geographic location, threshold amount, type of merchant, etc.) and undertake those that will more likely be accepted, thereby skirting the supposed failsafe measures currently in place. Additionally, a typical operation known as “cramming” involves the accumulation of small charges ($10-50, for instance) sporadically over a significant time period so as to increase the chances that such actions go unnoticed by both the account holder and the financial institution, particularly if monitoring by either party is limited. In essence, in each situation, the criminal element has realized a means to evade the security measures implemented by the financial institutions; there are thus great needs, again, to overcome these potential pitfalls.

Of particular importance is the typical scenario wherein the financial institution (bank or creditor, for example) detects suspicious activity and tries to contact the account holder. If such a communication fails (at least at that moment, such as if the account holder is asleep or otherwise indisposed), then much of the time the actual transaction is actually processed (depending, for instance, on the amount of money involved; the lower the amount, the more likely the transaction will proceed to any inconvenience at that time for either the presenter or the retailer). Otherwise, the potential for an interruption during the communication attempt may prove problematic to the degree that any account suspension due to such glitches may be too great a problem for the bank/creditor to want to cause such possible distress and/or other inconvenience to the account holder customer. As such, it is currently a common exercise to avoid such temporary suspensions unless proper communication is achieved or, alternatively, if the transaction is below a certain amount threshold, as noted above.

Furthermore, other systems have been developed that try to implement verification processes (passwords, etc., for example) to permit further financial account activity. However, even the most advanced versions of these systems utilize a single certification point and require the use of an easily (in most instances, at least) stolen password to verify identity. Even if verifications are attempted, particularly if there is questionable activity involved, certain communication platforms may still be insufficient to thwart unwanted and potentially criminal activity. For instance, the simplest of communication operations, such as SMS notifications, may still not get to the actual user until after a suspicious credit card transaction occurs. The lack of any other verification techniques for such a purpose leaves the financial institution, and the user, for that matter, at the mercy of almost happenstance; if the user is, again, not by or near his or her phone, or not at another registered phone or other communication device (even if the communication is made by email, text, etc.), then the entire transaction will fail. If it is an actual desired transaction (if it is true in that sense), it could be prevented rather than permitted, leaving the actual, verifiable user unable to complete a transaction. In other words, the systems currently in place are noticeably deficient in that they either provide too stringent a system of protection (leaving, again, the account holder/user at the mercy of having a communication device that is, for instance, fully powered, at the point of purchase, for verification purposes) or a system that could permit a bad actor too easy a manner of avoiding the preventive measures sought through such a base security procedure. In those instances, it could be, for instance, greater than 24 hours before such a fraud is noticed, leaving, again, all the entities involved at the mercy of a fraud already committed by someone (or many persons)(or some entity), leaving an innocent party (or parties) forced to pay for such an illegal transaction.

Further attempts to protect account information during transactions include the implementation of a verification enrollment program involving a merchant and an account holder. Such a program allows for such parties to utilize a verification technique whereby the merchant notifies an intermediate verifier that has access to the account holder's communication device number in order to call and request input of a specific pass code. The system requires the account holder to download an application unto a specific communication device to link with the verifier; the merchant must also utilize the verifier service in this manner for the overall system to function properly, apparently, as well. Upon request of a transaction, the system realizes the account holder's information and automatically communicates with the enrolled communication device and awaits input of the aforementioned pass code. If the pass code matches a stored pass code, then the merchant is allowed to proceed with the transaction. Although such a system appears viable on its face, in actuality it is open to many attacks by a bad actor, particularly since such verifications are limited to a single contact point. If the communication device (such as a cell phone, for instance) has been stolen, the potential to uncover the pass code through analysis of past inputs leaves the user susceptible to identity theft. Additionally, a bad actor has the capability of forwarding the necessary communication link to another device if access to the enrolled device has been permitted (even after return of a stolen phone, for instance, particularly in a surreptitious situation wherein the initial enrollee does not realize such has occurred). If an account number has been stolen, as well, and the pass code has been uncovered, as noted above, then the bad actor may still have the capability of raiding the enrollee's account, unbeknownst to either the account holder or the merchant. Otherwise, the overall limitations of such a system are further noticed as there is always a need to, apparently, have the account holder provide the pass code verification in person and/or in public, leaving the possibility that a bad actor may view such an input. Additionally, the system does not take into account the financial institution itself; if a bad actor undertakes such a possible illegal theft scheme, there is no prevention of liability on behalf of the financial institution itself. Lastly, the overall system is taxing to undertake in terms of bandwidth; in actuality, the utilization of short message service (SMS) pathways to provide such verification capabilities are virtually impossible within such a structured program. The input of information in reply to a specific request must be performed by a party, not through a latent response mechanism. To achieve such a result, larger bandwidth relays are necessary, leaving the system as a rather significant tax on the overall communications systems in place to begin with, as well as one that is highly susceptible to hacking and information theft. As such, these overall downloadable application enrollment processes are extremely limited in effectiveness without significant changes to their basic configurations. As well, these are limited to merchant/account holder transactions and do not provide further protections for other financial transactions that may be sought in other situations.

There have also been proposed (and, in certain locations, implemented) more exotic and technical systems and methods for validating credit card holder identities. However, these systems likewise exhibit significant drawbacks. Some are too complex and require new card types to be issued and/or new merchant hardware for their use, and others are too easily learned and passed on to other users. Others have been avoided by the financial industry due to the necessity of changing such card articles at too great an expense (such as, for instance, including microchips, RF sensors, and the like, within the card bodies). Other activities have included the attempt to couple photos of the user in an on-line environment, at least, to a system present within a retailer's establishment. In all such scenarios, the difficulties in implementation were greater than the industry was willing to withstand, ranging from costs to privacy concerns for the card users themselves.

Basically, it is clear that even within the most advanced system a continuous link is needed in order to verify identity through a mobile device. A password is required and any break in signal causes a transaction to be declined. Such identity verification systems all lack the capability of multiple certification points. They also lack the ability to accept different types of simultaneous verification points such as the requirement of SMS and email verification for a specified transaction, not to mention the ability to leave a transaction as pending while awaiting secondary verification. Overcoming such deficiencies would thus be a benefit for corporate customers and for on-line shopping, at least. Additionally, and in a slightly different vein, such systems also lack the ability to offer certain benefits to card users, such as, for instance, shopping bargains from competitors of a certain store (wherein such competitors may be paying clients of the card holder's backing financial institution or even of the specific internet search engine utilized for a specific on-line shopping transaction). Certainly, pop-up ads and the like may be possible through on-line websites, but to specific cell phones and other like mobile devices, such possibilities are currently lacking, particularly since it is difficult to pinpoint locations correlated to desires of such a potential card-holding, cell phone-carrying, customer (and thus the utilization of ads in this manner directed to such specific individuals, rather than to a widespread population of phone users). Such versatility, particularly in conjunction with a verification system for bank account fraud elimination would be desirable to many consumers. Such base systems, let alone those with this versatile ad supply function, are nonexistent as of today. Furthermore, such typical verification systems also lack the ability of buyer-seller portals for pending on-line transactions for the transfer of desired information before a secondary verification identifier to permit the reliable completion of such a transaction. Finally, there is currently lacking, as well, the ability to provide a central monitoring system for emergency requests sent from bank account customers' cell phones using, as an alternative, at least, solely an SMS platform to reduce bandwidth usage for such necessary communications. In essence, although many resourceful measures for preventing bank account fraud have been published in existing patent literature, none have offered a system in which security may be enhanced with infinite scalability to best ensure verification of identity, etc., of the instant account holder (or, at least, of the instant transferor of account information for a financial transaction).

As such, as outlined above, despite the large amount of attempts for such reliable theft and/or fraud prevention procedures, there remains a distinct need for a simple verification method for ensuring account use is by the proper account holder, thus allowing for the detection of stolen or other type of fraudulent bank account information use at the moment of actual activation. To date, as noted above, the possible options have been deficient or too complicated to establish as a suitable means for this purpose, particularly on a large-scale, widespread basis. A development that permits ease in not only implementation but utilization, coupled with complete (if not substantial) reliability that any such account transaction is authorized, would be highly desired within the industry from the financial as well as the consumer standpoint.

Furthermore, as noted above, even though there is much discussed in terms of financial account protections in this respect, the ability to provide an even greater platform for protections from the basis of an operating system, rather than just within a financial account, has proven extremely difficult to accomplish. The system described herein goes further than any other before to accord the benefits needed in this respect.

### SUMMARY AND ADVANTAGES OF THE INVENTION

The present invention pertains to a novel method of providing direct communication verifications of a person's identity and ultimately their desire to achieve a requested financial account transaction result in a reliable fashion. The overall system depends on a string variable method that accords a limited number of representations to all the words and numbers of a specific human language in order to provide a suitable machine language translation for specific contact point identifications. The system then allows for electronic communications to be undertaken that request a response from a predetermined contact point group (of any population size) that meet a base criteria (in this situation, association with the identity of an account holder). With the response from the address to which the communication is sent, the responder can be properly verified through the string variable algorithm that ensures the identification of the person (or other entity) responding in such a fashion is reliable. Thus, the string variable system permits the only needed capability to determine, in conjunction with the responder's verification contact points (such as cell phone number, IP address, and email address, at least), that each responder actually meets the initial communication request criteria required for authorization for a transaction to proceed. In this manner, as outlined below, such an algorithm allows for reliable and verified communications to occur under any type of prescribed protocol to ensure specific communications, responses, requests, etc., are made from and to required contact points in an instantaneous manner. With this background in place, there is provided, as described in greater detail below, an entire system allowing for the elimination of financial account (for instance, checking account, retirement account, savings account, investment account, credit card account, debit card account, and the like) fraud through the capability of allowing for reliable prescribed contact point communications such that the underlying system verifies the authenticity of the individual or other entity initiating a financial transaction with a specific financial account, thus allowing for instantaneous response to and between the backing financial institution and the merchant (or other entity) permitting the authorization to further the transaction at that moment.

The inventive system is advantageous in that it provides a remote wireless contact point for communication between a financial account provider (or like entity) and an account holder that automatically recognizes that person and his or her account upon use within a transaction. With such a degree of reliability permitted through a simple connection between account holder and account provider, many other advantages are present as a result, including the capability of determining verification of the account holder automatically upon actual transaction initiation. As well, the system provides the advantage to send automatic communications through a wireless protocol upon entry of account information into a transactional system to the account holder allowing responses upon communication (including just a simple log-in to the system through an email, text, call, and the like) from an account holder, contact point, etc., indicating any problems, as well as any requests for other types of actions, all through SMS messages. The system also permits other communications through email, text, phone call, etc. (including SMS, if desired), for other types of requests, if the user needs to provide such notifications, etc. As noted above, such a system advantageously allows for an account holder to directly and instantaneously receive verification notifications from the algorithm system with such verifications supplied based upon his or her profile criteria generated within a prior set-up between the account holder (user), financial institution, and the algorithm system, with the capability of the account holder and/or financial institution to modify verification contact criteria within such profiles subsequent to such an initial set-up. Additionally, as alluded to above, the inventive system may be operated through any electronic media resource, including texting, calling, emailing, etc., via phone technology, including, without limitation, VOIP, and even through an HTML log-in program on a computer (tablet, desk top, laptop, etc.), such as for primarily on-line shopping and other financial transfer operations, without losing any degree of capability in terms of reliable recognition of the entities involved (account holder, financial institution, merchant, etc.) through a simple request and reply communication action. Still another advantage of the inventive method is the efficient manner of rapid reply to a request through the inventive algorithm that reduces account holder identity, information, and other considerations, as well as financial institution, identity, verification requests, and transaction location, etc., to a machine language translation to permit such low-bandwidth communications for such a reliable, straightforward account holder verification purpose.

Thus, additionally, the inventive system provides the overall advantage of such an instantaneous verification system without the need for actual reply from an account (card) holder to achieve the necessary level of reliability for all parties involved to consider the transaction legitimate, through some type of acceptable response from the account holder (such as through an automatic email reply, for example). Another advantage is that beyond the initial set-up between the card holder and the financial institution, and then the financial institution and the algorithm system that undertakes the verification activities, and lastly, the algorithm system and the financial institution and the account holder, there is no need for the disclosure of any information to any other entities regarding the card holder's identity or other information. Yet another advantage is the capability of allowing for such an algorithm system to safely and securely not only communicate such verification processes to the entities involved, but such a system also permits adjustment and/or setting of different levels of verification protections such that specific criteria may trigger extra communication requirements to larger numbers of contact points, etc., in order to allow for reliability regardless of the transaction involved. Still another advantage of this system is the ability of the algorithm system to permit the account holder (user) to set up automatic replies from his or her required contact point(s) to meet the necessary profile considerations for transaction legitimacy, particular if such an expected shopping exercise includes certain purchasing amounts that exceed a threshold level. Thus, as another advantage, the inventive system provides great versatility and quickness for a whole range of shopping, etc., benefits, while primarily serving the entities involved within a secure network to provide the base reliable protocol of verifying identity without any invasive actions or other type of interruptions, all in at least a nearly instantaneous timeframe.

Taking these types of contact point verifications, then, the ability to expand the overall consideration to protecting not only a financial account from attack in this respect, but any type of on-line request (whether through the world wide web, a remote card reader, a person's SmartPhone, etc.) through constant and consistent monitoring of the verification and status of an operating system (herein, also referred to as computerized device, and possibly user) as well as the verification and status of a server, too. Accordingly, this invention encompasses 1. A computerized method for substantially monitoring operating systems and servers concurrently for verification of device identifications, user identifications, and server program validity, said method including the utilization of an intermediary algorithm system for electronic communication with said device and said server program, wherein said intermediary algorithm communicates with said device and said server through established contact points generated through a variable string wherein verification of identity and status of said device and said server are provided upon reply of a request from said intermediary algorithm system to both said device and said server through a specific contact point, wherein said verification is determined upon receipt of a timely reply form said device and said server through the same contact point from which each separate request is made.

2. The method of claim 1 wherein said method includes the steps of:

1) generation of a computer device profile within said intermediary algorithm system, wherein said device profile includes verification contact point requirements to be undertaken by said intermediary algorithm system upon utilization of said device within a request or transaction with said server, and wherein no other information pertaining to said device is shared with or otherwise stored within said intermediary algorithm system;

2) generation of a computer server profile within said intermediary algorithm system, wherein said server profile includes verification contact point requirements to be undertaken by said intermediary algorithm system upon utilization of said device within a request from or transaction with an operating system, and wherein no other information pertaining to said server is shared with or otherwise stored within said intermediary algorithm system;

3) establishing specific contact point identifications with said intermediary algorithm system through an initial communication with each required verification contact point within both profiles of said device and said server, wherein each of said specific contact point identifications are defined by unique string variables generated by said intermediary algorithm system;

4) initiating a request or transaction by said device to said server;

5) requesting verification of the identity of said device by said server through communication with said intermediary algorithm system prior to completion of said request or transaction;

6) undertaking communication between said intermediary algorithm system and the required verification contact points associated with said device such that substantially instantaneous determination of verification is accomplished through the reception of proper signals from said verification contact points by said intermediary algorithm system in response to requests sent from said system to each of said required verification contact points for that specific transaction, such that if the proper signals from all such required contact points are received then said intermediary algorithm system determines the device is authentic for such a transaction and if any signals are determined improper, then said intermediary algorithm system determines said device is not authentic for such a transaction; and

7) transferring the results of step “6” from said intermediary algorithm system to each said server;

wherein said intermediary algorithm system provides verification notifications and responses to said server without any required human interaction;

wherein said results transfer step of “7” is undertaken without the need for any input or disclosure of any personal information of said device to said server; and

wherein said method is undertaken through the utilization of at least one computer program within a non-transitory medium.

The inventive method also encompasses a method of monitoring the results uncovered by said intermediary algorithm system in verifying and validating such transactions, requests, etc., of the devices and servers. Additionally, then, the overarching monitoring system may provide a means to utilize a “perfected” server (one that does not show any questionable activity over a certain time span, such as a week, a month, three months, etc., in terms of denials of verifications, virus and/or hacking actions, and the like) as a “dangling carrot” to potential bad actors for hacking, etc., discoveries and possible offensive retaliation to prevent further hacking, etc., through the same source.

For this inventive financial account protection method, the term “device” or “account” is intended to pertain to any type of computerized machine, etc., that allows a person or other entity access to a computer server. Thus, such a “server” is intended to encompass any computerized platform that includes web pages, search engine capabilities, financial account storage and usage, etc., basically any such program, and the like, in an on-line environment.

The term “computer program” or other like description is intended to denote that the overall method is controlled by software code and through the utilization of a computer machine (or the like) for implementation and utilization. The present invention may be implemented on a program or code that can be stored in a computer-readable (or electronically-readable) medium and that can be provided in a WAN environment. The overall system may be implemented onto a server using, as non-limiting examples, Apache web server, MySql on Linux, Oracle on Linux, Java servlets, Applets, HTML, JavaScript, Java, C#, and Microsoft's .NET, in such a manner as an account holder or account provider would have access thereto on demand through a secure connection. Such a server may reflect implementation on the Internet, an intranet, or an extranet. Any software platform may thus be employed to implement the underlying algorithm system, such as JAVA, Linux, and the like, and the code itself may be written in any language, including, BASIC, COBOL, C+, C++, and the like.

The term “intermediary algorithm system” (or just “algorithm system”) within this disclosure is intended to encompass the incorporation of a computer program as a conduit between the device, the server, and any other party to a transaction between the device and the server that includes the herein described and delineated VARSGR algorithm. Such a conduit thus serves as an information storage and operation source that further assigns string variables to all information inputted (whether during account creation or at a time subsequent thereto) for security purposes and also includes communication capability to generate and send requests electronically to such verification contact points, the device, the device user, and the server for responses via the same electronic channels. The overall algorithm and the system in which it is employed for this inventive method is described in greater detail herein.

The inventive system thus includes the utilization of a string variable algorithm (Variable Assigning Request String Generator and Receiver Algorithm, or VARSGR, for short) to translate human language into machine language with the capability of applying unique characteristics (in this situation, variable strings) to each entity involved in the overall protocol (account holder, financial institution, contact point individuals, etc.) in relation to specific signals, etc., generated from each entity's electronic media source to provide sufficient information for the system to reliably recognize the identity of the entities involved from the receipt of an access communication from such an electronic source alone. Furthermore, the system includes the capability of such account holders to modify the protocol set up for such fraud elimination purposes to also allow for varying levels of protection through changing the number and type of contact points as deemed necessary and/or desirable in relation to specific types of transactions. Additionally, the system allows for the account holder (user) to also adjust his or her capabilities for responding to an algorithm (VARSGR) request during a planned shopping experience (or experiences) by automating the algorithm system response from some of the contact points provided within his or her (or its) profile within different levels needed for verification purposes in such specific instances.

More succinctly, the invention encompasses a computerized fraud elimination system (or, alternatively, a verification and/or validation system) utilizing electronic media sources for communication between a computerized device and a computer server and, optionally, a third party (such as the device user, for example). Certainly, when a request or other transaction is undertaken by a device user through the device, the involvement thereof such a third party is necessary. In any event, the base (intermediary) algorithm system includes the initial creation of a device profile as well as a server profile for further utilization at any time and with any other operating system (device) and server (as well as for the device user him- or her-self). Upon profile creation or subsequent thereto, as the case may be, each party (user, device, and server) inputs profile information to allow for the intermediary algorithm system to distinguish each party's identifications. Thus, a specific client number (or like assigned label) to provide specific identification of the account and the parties involved may be generated such that the profile information itself (such as account number, etc.) is not transferred to the intermediary algorithm system, but the inputted information is sufficient for full identification to be permitted for both account parties (tokenized). The profiles thus also include verification contact point identifications for the intermediary algorithm system to access electronically at the moment of profile creation in order to generate specific string variables in association with all such contact points. In essence, the algorithm system contacts each contact point electronically with a request for specific verification thereof; upon receipt of such initial verification of identity, and, as well, confirmation from the account holder directly that all such requests are proper, the algorithm system institutes the necessary string variables associated with each verification contact point required within each profile for a specific account. Once the algorithm system institutes these variables the contact points are indelibly identified within the context of the algorithm system and the string variables cannot be modified without re-establishing the profiles themselves through an entirely new account. In other words, once the contact points are set in terms of string variable identifications within the algorithm system, they cannot be altered without knowledge of both the financial account holder and the financial institution. In effect, however, as alluded to above, such modifications will generally not be necessary. Thus, the string variables associated with specific verification contact points within both the device and server profiles provide the necessary verification capabilities upon establishment of the string variables associated therewith by the intermediary algorithm system. As such, the algorithm system is thus tied to specific electronic media sources (again, such as cell phone, email, text, and the like) that are utilized to not only set up the string variables for each required contact point associated with the device and server for the subject account (as noted above), but also to effectuate the necessary verification requests and responses thereto upon any attempt at a request or transaction involving the two parties. Thus, since each string variable is unique and is never duplicated, allowing for individualized identifications for each and every contact point for not only a specific financial account, but for every such verification method protocol created for all such financial accounts handled by that specific financial institution. In this manner, the algorithm system not only ensures every contact point associated with a specific device is unique and verifiable simply through the initiation and activation of the aforementioned individualized profiles created for each party (for both the device and the server in a separate manner), but that each contact point in total over the entirety of all such accounts are distinct and verifiable for accuracy and reliability, as well. As described herein, the inventive system, once the necessary profiles are in place, automatically recognizes the identity of the subject device and any and all other required verification contact points associated with a specific transaction involving that device. This overall method is unique and heretofore unheard of within the context of operating system, etc., identification protections. As such, this is assuredly not a broad abstract idea, but a definitive process that requires specific method steps that have no past basis within this field.

Thus, within the context of this overall method, the term “proper signals” as it applies to communication between the intermediary algorithm system and all verification contact point requirements for each transaction within the profiles of both a device and a server is intended to reflect receipt of a response from all required verification contact points in reply to a request from the intermediary algorithm system. Such a response may be provided with an automatic reply (such as through an email, text, or cellphone platform) set-up by the device specifically in anticipation of such a transaction. Additionally, a response through a specific reply code from, for example, the device's (or device user's, for that matter) immediate communication device (e.g., in his or her possession at that moment) coupled with an automatic or other type of set reply from any required verification contact point would be considered “proper” in this context since, as above, it is evident that the account holder has specifically arranged for such a reply with the expectation that he or she is undertaking a transaction in this respect. If the user misplaces or has stolen his or her device (including, for instance, an account number, account card, phone, tablet, and the like), then all that is necessary to prevent a “proper signal” receipt by the intermediary algorithm system if such information is utilized in a transaction attempt is turning off an automatic reply, responding with a specific indication that the situation is “improper” (which can be read by the algorithm system as “improper” in that context), or even turning off or otherwise refusing a reply from any required verification contact point for that specific type of transaction. Because the algorithm system has instituted string variables for each required verification contact point, any attempt to alter the source of a reply to a system verification request would be easily and suitably interpreted by the algorithm system as an “improper signal” since the request and response must be sent to and received from the same source indicated by a non-duplicated, unique string variable. Likewise, if a device user (or device itself) has his or her phone stolen, an additional required verification contact point (or more than one, for that matter) may still be employed for overall verification purposes. If only one reply out of at least two in response to an algorithm system request is considered true in relation to the requirements for contact for authentication purposes in relation to a specific transaction, then the signals would be considered “improper” and the transaction would be refused. Thus, if all requests and responses in this context are considered trustworthy, only then would the system consider such communications as “proper signals” and allow the transaction to proceed; if even one required verification contact point is deemed untrustworthy in this manner, then the system would consider such communications as “improper signals” and the transaction would be terminated. Such a situation applies to the verification contact point requirements set for each transaction within a subject server's profile, as well. Furthermore, if the verification contact points of the user, device, or server receive any requests from the algorithm system that are clearly improper (for instance, if the device or user is not involved in a request or transaction at the time, or if the intermediary algorithm system profiles for each entity are set in a specific manner for a dormant account that is now being accessed, as examples), then either holder or institution may generate an overriding response to the system (such as, for instance, typing “NO” or “FRAUD” or like message) in reply as an authoritative demand for action to be undertaken at that moment. Although human interaction is thus not a requirement for verification contact points to send replies to the intermediary algorithm system, these types of exceptions and allowances are certainly possible, if desired and deemed necessary.

In general terms, then, the overall system thus depends on the implementation and utilization of the following algorithm, as presented in the following sequential steps (using financial institutions and account holders in place of devices and servers in this context):

1) Creation of offered subject matter (in this instance, verification contact points associated with a specific financial account holder and financial institution for reliable transaction capabilities) followed by a search of a properly parsed database for individuals or personnel that meet the criteria associated with such subject matter as determined through the adoption of the string variable system (in other words, upon determination and disclosure of necessary verification contact points and identification information, said algorithm system will search for all such required signals/individuals/etc. within the necessary and/or supplied population database for pre-verification purposes);

2) The database then matches the string determining such a population and the IP addresses of a set population of the persons (or more succinctly, the required verification contact points) that meet such criteria (as set within the financial account profiles described above); the search stops when the string is finished through verification that those selected match all pre-determined criteria;

3) The database then sends communications to those people and only those people that the meet criteria for the subject matter involved (whatever is being offered); such a step is accomplished through string variables attached with human language (or machine language, if human interaction is unnecessary);

4) Those that receive communications in this manner then must respond with the text or email (anything else electronically) that they received; correlated machine language has to be in the response (through the string variable) and such a response must be sent from the address at which the person received it;

5) The system then matches all machine language subject matter returns (and thus all that include the string variable) from sent-to IP addresses from the group of persons that met the criteria pulls identities from the group to the string variables (with a finite count of possible persons to be selected in this manner);

6) When the matches are then made, the IP address and the profile including the embedded contact point(s) is pulled through the string variable as indications that the selected people wanted this result;

7) The system then responds with a confirmation that the person's (verified contact point, in this instance) desired result has been granted and then updates the database to remember the result and then not attempt to accomplish it again;

8) The person's (persons′) profiles that meet the criteria and respond are then kept within the algorithm system as proper contact points with their verified signals in place.

Within the overall monitoring and protection method described herein, the algorithm system is implemented to provide the necessary communication conduit as well as verification determination component to allow for an entirely automated process to be undertaken. Thus, upon creation of a device and/or user profile within the algorithm system in relation, the algorithm system will generate a specific string to bridge both entities together based upon random variables that become set for that specific purpose. As well, once an account holder creates his or her or its profile in relation to a device (or account), a different string is generated that relates to the string for the specific server for that specific device (or account). Once the profiles are then created, and verification contact points are specified by both the user and/or device and the financial institution (and are kept separate and unknown by the other entity), the algorithm system then creates a string for each such contact point that initially sets the variables associated with each contact point that cannot be altered. Any other contact points added later by either entity will also be assigned a string variable in a like manner. Thus, once these strings are generated and incorporated within each profile, the user and/or device or server may set any requirements as to actual communication with any number, sequence, etc., contact point to ensure algorithm system requests will be sent to such necessary addresses (email, text, phone, etc.). Since each contact point has its own string, any deviation from that specific identification string (such as a different phone number, a different email address to which an initial request has been forwarded, as merely examples) will result in a determination of an improper contact point. Likewise, if the response generated to the algorithm system request does not correlate to the set string for such a required contact point, then verification fails and the transaction is not allowed to proceed. As noted below, the sheer number of available string variables allows for specific contact point identifications in such an exact manner that there is no feasible way to break such a protective combination. The same potential resides with the profile for the financial institution, with the added capability of actually having the string variables (in table form) for each necessary verification contact point continuously rotated, reversed, switched, etc., in order to add a further level of security.

### BRIEF DESCRIPTION OF THE DRAWINGS

FIG. 1 is a flow chart of one possible embodiment of a potentially preferred operating system monitoring and protection method.

FIG. 2 is a flow chart of the utilization of a multi-monitor system for multiple servers and operating systems governed by an OVER monitor program.

FIG. 3 is a flow chart showing a perfected monitor system copied and utilized as a potential hacking resource to uncover and affect such unwanted bad actors.

### DESCRIPTION OF THE INVENTION

As noted above, the key to the overall effectiveness of the fraud, hacking, etc. elimination protocol is the utilization of the VARSGR algorithm to monitor and protect on-line activities through requests from devices and/or users to servers. This string variable algorithm allows for the reliable connection between device and server and verification contact points, at whatever level and/or number required for such purposes. Such string variables allow for an inordinately high number of variations of identification possibilities in relation thereto, thereby allowing the system to not only easily distinguish one account holder from another, as well as one contact point from another, through a simple text or email (since the initial confirmation of identity directs the system to apply string variables to each individual card holder, contact point, etc., that are then related specifically to those persons, contacts, etc., alone).

The algorithm itself, as noted previously, is referred herein as variable assigning request string generator and receiver. In greater summation from above, this algorithm is provided in a manner in which all searchable criteria are assigned a variable using the letters of the alphabet and the numbers 1-9 to create a string of variables that can be sent via any electronic media which may include but is not limited to SMS or email. These texts or emails can include other information. This information may be viewed, read, or acquired by either human or digital systems to solicit a positive or negative response. These responses are differentiated in the fact that a positive response is viewed as a reply to a request via any electronic media including but not limited to SMS or email. The account holder, contact point, etc., responses are then received by the algorithm and evaluated for authenticity by verifying account holder, contact point, etc., identities through matching the string (request)(which is time-stamped upon generation by the algorithm system variables) sent to a verification contact point email address, IP address, and/or cell phone number with the email address, IP address, and/or cell phone number from which the necessary response to the string is received. With the string variables in place and associated with each original or modified verified contact point, any lack of matching of string variables at a later time would indicate the contact point is not authentic and a fraudulent activity is taking place.

Using, again, a correlation between accounts and devices, in this respect, the method may be further delineated as follows: if the account holder, contact point, etc., response is found to be valid, the algorithm the matches each string variable to the system search denoted by each variable to evaluate that a matching request is still available and that the account holder, contact point, etc., still meets all requirements of the sent request. As well, although such a system is designed to act substantially instantaneously, in actuality, it will hold the overall instance or transaction open until the required number of responses with strings is achieved after the algorithm system sends its initial requests (or until the system is effectively timed out without having received a response from every required verification contact point). If a matching request is still available, the algorithm sends confirmation to any and all known addresses of an account holder, contact point, etc., responder through all available electronic media that such a response was accepted and updates any and all databases used by the algorithm system. The database in this situation is the aforementioned intermediary algorithm system acting as, basically, liaison between the account holder, financial institution, and merchant (or other third party, as described above, including another financial institution, such as a transfer from one account to another, or from one account holder to another as a payment, transfer, or other like situation, as non-limiting examples)(for each transaction, at least). The matched contact point, account holder, etc., response is then archived within the algorithm system for further verification purposes. If a contact point is changed by the account holder or financial institution for any transaction, then proper notification is also provided both entities, both to ensure such requirements will be understood and further properly handled in the future, as well as to alert all involved that such a modification has been applied. If the modification has not been requested, the algorithm system can thus be properly alerted itself and such a change can be prevented.

Upon initiation of a financial transaction utilizing the account of the holder, the algorithm seeks all required contact points through the electronic media available and required in association with the profile of the financial institution and/or account holder; if all contact points are verified through the algorithm, then the system communicates such a result to the financial institution and awaits the request to inform the merchant (or other third party). If all contact points required are not properly verified, then such a result is conveyed to the financial institution for handling in that respect, as well. The capability of the overall system is that the algorithm may be utilized to dial in a specific “lock” mechanism for any type of transaction in relation to the verified contact point number and type. With the string variable configuration, this algorithm can thus provide 1,679,616 different assignable variables for each definable search criteria entry by utilizing the upper case alphabet and the numbers 1-9 in combination of 4 characters, as one example. Although probably unnecessary, the algorithm has the capability, as well, to incorporate lower case alphabet characters which would increase the assignable variables per 4 character combinations to 14,776,336, and even further if larger character combinations or even other symbols (Greek letters, graphic symbols, such as &, *, and the like, as, again, merely examples) are employed. Basically, the capability of the algorithm system to apply string variables for identification purposes is, ostensibly, infinite, with the only real limitations based upon human and/or hardware capabilities. As such, the scalability of this overall algorithm system is, again, potentially infinite as the combinations available for contact point purposes are truly astronomic in number. Thus, the capability of adjusting any profile verification requirements may be made as many times as desired or required by the account holder and/or financial institution in order to ensure that repetition of the overall contact point requirement protocol will not result in fraudulent card activity due to hacking or other type of improper action. Furthermore, the financial institution may also choose to undertake a simple reversion of the pertinent profile string variable tables thereby changing the string variable request(s) sent without changing any functionality or view seen by the account holder, and, perhaps more importantly, without any need to undertake programming changes within the software code. In this manner, the security levels may be increased exponentially without any functionality, programming, or format change, and at the financial institution level, thus preventing any definitive hacking capabilities since the account holder will have his, her, or its own standards in place that may or may not be accessible by the financial institution. The lack of crossover in terms of requirements set for algorithm verification contact points for any account, or even as low on the pyramid as a specific type of transaction within any account, thus allows for even greater levels of security with a (substantially) instantaneous verification system.

Additionally, to further show the benefits and highly unexpected value of this inventive algorithm, multiple search criteria are placed in the request producing the string variable. To ensure this system will allow for utilization with even the oldest SMS platform, the string variable has been limited to a maximum of 23 separate classifications of definable criteria for matching string variable with database information. These oldest available SMS platforms have 142 character limitations. The reason the 23 separate classifications of definable criteria is not the product of 142 divided by 4 is that the system uses specific symbols to locate the beginning and ending of the string variable and breaks are denoted with other specific symbols between variables. Again, these combinations can be scaled to any number, dependent upon the selected levels of variable capabilities defined by the hardware employed or human element involved. Thus, again, the numbers provided above are non-limiting examples of the effectiveness and capability of the algorithm system described herein.

The number of classifications needed and the priority of each classification is dictated by the database algorithm pertaining to setting priority of search classifications such as, for instance, considerations such as color, date, common name given to item, and any other criteria that database operator wishes to use to filter for a particular item or service (here, for instance, in relation to providing required verification contact points to ensure a financial account transaction is true). It is the matching of these generated string variables to the account holder's/contact point's variable assigned that allows the system to move under one instance therefore allowing requests for verification purposes and allowing full functionality of the underlying system.

Thus, the inventive system solves the noted typical financial account fraud elimination method deficiencies by creating a string of variables that can be sent and received via multiple electronic media. Such a medium is preferably a cell phone (of any type that allows for texting, emailing, or other type of textual communication), for obvious reasons. Additionally, the system may function properly through a user's computer, whether embedded within a laptop, tablet, desk top, or other large type, platform. Additionally, any wireless system that provides communication capability of the voice, text, email, etc., variety, such as a wrist-placed device, eyeglass device, and the like, may be utilized in this manner, too. The variables are assigned in relation to a request sent to an account holder, contact point, etc., over such a medium and upon confirmation of identity by verifying the contact point from which the response with strings came from is the actual contact point to which a request with strings was sent.

The system may be further implemented through the utilization of suitable readable screens incorporating requests, transaction details, transaction confirmations, request acceptances, transaction cancellations, etc., whatever communications are undertaken over such a medium for this purpose. These are provided below as merely non-limiting examples of possible screens including such information. The simplicity and effectiveness of the overall system is evident and is permitted through the above-described algorithm. Without the string variable capabilities, human interaction and involvement would be paramount to guarantee each request and procedural step is implemented properly and for the correct account holder and/or financial institution. The ability to relate the other considerations to this initial system provides highly effective extra benefits that make the overall system that much more attractive, particularly in terms of an all-in-one process that eliminates the need for workforce involvement beyond the potential for emergency calls due to unexpected system shutdown.

Thus, the VARSGR system basically creates a string of variables recognized by the system as defined through a platform (protocol) setup such as point-of-sale location, store name, number of certification points (verified contact points), and assigned letters or numbers to replace actual bank account numbers for enhanced security (the only defined information are contact points; all other pieces of information are replaced by variables that can be set permanently or modified at any time). The protocol, as noted above, allows for the creation and input of user (account holder) profiles in association with the target bank account (such as a checking account or any other defined account for which a transaction should require verification of identity of account holder in a timely fashion) held by an issuing bank (financial institution) including any and all contact points and defined levels of contact points. The bank account may actually include multiple sub-accounts such that a primary account number (or other type of identification measure that correlates a person, group, or other entity to an account or multiple accounts) is associated with a checking account, savings account, debit card account, credit card account, investment account, retirement account, etc., that may be governed through an umbrella profile with sub-profiles that require individualized specific verification contact point protocols as described and defined herein. It is certainly possible, and expected, that an individual or corporate account holder may have multiple profiles with different levels and contact points, as well. These profiles, as discussed above, may actually be turned on and off and prioritized in order, as prescribed by the account holder and/or financial institution, and modified in whatever manner desired, to actually exponentially increase security for each account.

One major component in the operation of the VARSGR algorithm system is that the string is sent to profiles which meet all search criteria so that only those users listed in the subject account holder profile associated with a specific account receive information. The system certifies that the contact point to which the string is sent is the same contact point from which a response is received. Without this guarantee, the overall system would most likely fail. The enhanced security provided through the string variable capability in this manner, particularly without any need for human interaction, has heretofore been unexplored within the bank account fraud elimination area.

As such, the system then matches the strings together for the verified contact points contacted thereby. Once the number of each response level is then achieved (which should be nearly instantaneous, up to about 20 seconds in duration, preferably within 10 seconds, more preferably up to 6 seconds, as merely examples; as noted, such requests to and responses from verification contact points should take less than one second to complete such verifications, thus providing a proper description of the term “substantially instantaneous”), the VARSGR system then sends a message of such a result to the account holder (user) and allows the transaction to proceed (as well, communication with the financial institution and, ultimately, the merchant involved, may also be implemented in this manner and for this purpose). This string variable thus verifies the true identity of those responding to such requests for responses without the need to request or divulge any personal information in the process. For corporate customers, the individual responding is identified since there may be more than one individual who can authorize a transaction. If, for example, a string is sent from a contact point to which the system did not initially send a string, the system identifies this as fraud and notifies the institution, user, and any entities needing such information of fraud attempt.

The security of the string variable algorithm system is such that messages cannot be intercepted and/or forwarded. Basically, the action of matching the strings from the point of response to the contact point to which the string was sent precludes any such interruptions, particularly as the speed of such signal transmissions are much too fast for any other actions to commence in that respect.

As also noted previously, since the variable string may contain other transaction information, such a device may also be utilized to send to different notifications, etc., to preferred merchants for electronic verification of stock and special offering of goods and services at discounted rates to the user. Such offerings would be sent via all media to all contact points, again relying upon the effectiveness and reliability of the string variable, itself.

In effect, the system itself can also permit the account holder to receive readable data sent by the string through a notification request of an attempted transaction in order to make his or her decision to verify the transaction including but not limited to amount, date, time, and name of merchant. In addition, the readable data accorded the account holder (user) may be limited to a series of numbers, symbols, and letters that can only be fully recognized by the system. In such a situation, however, the system would merely require the user send this string of variables back to the contact point from which it was sent to provide the verifications necessary. This may be accomplished by forwarding or replying to the transaction request, making the overall system very simple to actually utilize in this respect. The only requirement, important and necessary as it is, is that the response must be sent from the contact point at which it was initially received. This allows the user to avoid any need to certify a transaction with a pass code input. As well, it eliminates the ability to intercept the string and send a response from a false contact point, thus preventing any improper actions in that manner. Additionally, the system permits the utilization of auto-reply email to permit the aforementioned and described planned shopping outings, thereby permitting increased speed of transaction verifications at point of sale (no need to log into a system, need to submit detailed information, etc., of planned shopping, since the string variable recognizes the contact point automatically). This also eliminates the need for a user to provide any personal information regarding identity, activities, etc., including a planned shopping location. Furthermore, this capability also allows for multiple active contact points in effect at all times increasing the potential for transactions to proceed at planned shopping times and locations.

In addition, the string variable accords the account holder further flexibility by permitting the utilization of profiles with different levels at the same time. As alluded to above, such a potential situation allows for set profiles (or modified, as the case may be) to include certain response criteria, rather than all standard types for all types of transactions. Thus, the system may be required to communicate with specific contact points through specific email addresses or cell numbers for certain transaction types, not to mention the potential necessity for an increase in contact points, as well, all in order to increase security protocols for certain transaction situations.

The capability of modifying required verification contact points on demand through activation and/or deactivation of specific profiles associated with an account further increases the security features involved. This is particularly impressive as it may be accomplished without any need for new software or hardware, only a request from a verified account holder in relation to the algorithm system (with a proper verification for such a request to be made to the system). If an account holder or account provider (e.g., financial institution) seeks to modify the necessary contact points within their specific system profile for any type of transaction, either entity may simply send a communication in some electronic manner (text, email, etc.) to make such a change. As noted above, any such modification will elicit an algorithm system communication to all profile verification contact points to ensure such an adjustment is desired and proper of the pertinent entity. Additionally, since there may be an unlimited number of profiles associated with each user account, and, furthermore, an unlimited number of levels of security through contact point requirements, at least, for each account, as noted above, the system itself is basically infinite in scalability for such security purposes. Thus, the string variable algorithm allows each account holder access to what is in effect a potentially ever-changing combination lock with password protected access points, all with the ability to ensure any such changes are monitored for authenticity as well.

This algorithm thus allows for reliability in terms of the identification of the responding person (or persons) solely from the capability of the string variable conversion to determine, in conjunction with the responder's verified contact point, that the characteristics, etc., of the responder actually meet the initially requested criteria. The algorithm thus provides a system to eliminate bank account fraud by offering unlimited numbers of verification points per transaction and opening proprietary buyer-seller portals without divulging identity or contact information of the stated buyer. In addition, through the use of the most efficient means for transfer of desired data from internet searches, bandwidth use is reduced up to 66 times resulting in much greater efficiency (such as through the utilization of SMS for all communications to reduce bandwidth requirements for low-cost operations).

An electronic request or transaction may be blocked until a multiple of user identification verifications can be met (up to a set time limit, such as, as examples, 1 minute, 45 seconds, 30 seconds, 20 seconds, as low as 10 seconds, if desired) as dictated by transaction criteria that are set within the profile requirements. The number and nature of verification points may be specified by the user or financial institution involved in the transaction. The user must make his or her desired contact points available to the institution involved in the transaction and the number desired per transaction based upon the amount or other definable criteria. In addition, the system has the ability to identify levels and can be set to demand verification from one or more contact points within each level such as companies which require a secondary administrative approval per transaction. These certifications can occur simultaneously, therefore not impeding the timelines of point of sale transactions. The system also allows for multiple accounts to be held by one user. To the contrary, the prior protective measures undertaken in this vein have been shown to have high operating costs, large equipment investment, and/or inconvenient use or infringement upon account holders' privacy.

The overall system is utilized, as well, with any withdrawals from (and even, in some situations, deposits to) an individual or corporate checking, savings, retirement, or other investment account. There may be instances where an account is accessed in an improper manner such that a bad actor may seek to remove available funds (up to the permissible amount) from another's account (as well, a bad actor may seek to deposit funds into a potentially dormant account to hide such ill-begotten assets, with the expectation to withdraw the same at a later date; this system allows for such deposits to be scrutinized, particularly if the typical set-up would not consider the deposit and withdrawal of the same amount of funds suspicious). If such an actor also has access to acceptable identification information (such as a social security number, a false ID, overall base information, such as address, phone number, and the like), then the capability of withdrawing (or depositing) funds from such a hijacked account is increased, too. Basically, the standard methods of stealing account information and identities leaves such types of accounts susceptible to attack in this manner. The overall system thus overcomes these account problem issues through the utilization of the string algorithm. Upon any withdrawal transaction, whether through electronic debit (as above) or even through check, withdrawal slip, telephonic request, etc., the system would include the requirement that any such action must meet the profile requirements instituted by the account holder. If the necessary contact points are not properly contacted by the system and/or do not properly reply to the algorithm system within a set amount of time, then the transaction would either be stopped completely or at least delayed until proper verification in this way has been provided. This allows for a number of improvements within the financial system in general, particularly since such stops could provide suitable alerts not only to the account holder of a possible invasion by an outside party, but also the lack of sufficient funds automatically. This could thus permit a simple low-bandwidth notification system that would prevent overdrafts and loss of actual funds instantaneously. Additionally, in terms of checking accounts, at least, the potential for delays in available funds transfers, either deposit or withdrawal, may be removed with this variable string algorithm system. With substantially instantaneous verification of identity through the request and response procedures set in the profile associated with such an account, situations such as out-of-state checks, $5,000 upper limit instant accessibility for large deposits, etc., may be avoided, thus allowing for better access to funds for all parties involved.

Additionally, the VARSGR algorithm may be employed to prevent any attempts to open improper accounts, too. Basically, banks are overseen, to a certain extent, at least, by an overarching system that allows for communication between such financial institutions in order to determine if certain account holders have other accounts with the same entity (or another bank). Presently, such a system is only in place to detect such other accounts if certain account holder information is inputted within a search field within the controlling database. Thus, if a person's identity is stolen, such as a social security number, full name, address, etc., a bank would not have any means to uncover any bad actor posing as another person in such a situation and the database will only indicate the existence of other accounts, not if such a new sought-after account was authorized by the actual account holder. The VARSGR system can be configured to have the financial institution correlate the presented account holder identity to other accounts and require verification contact points to respond to authorization requests in the same manner as described above for transactions. In this manner, if an impostor tries to open an account, whether a new checking account, credit card account, etc., the algorithm system can detect any problems and prevent such an attempt, again, nearly instantaneously. Thus, if the system seeks a response to a request from a verification contact point that has is its own specific string variable, and either receives no response or a negative response from such a required contact point, the account creation can be stopped and the proper authorities can be notified at that moment to apprehend the bad actor on site. The same capability to notify the police or other officials for such a purpose is clearly a possibility if a transaction is nullified or otherwise denied at a point of sale (such as at a merchant or other retail or restaurant establishment), too.

Through the utilization of the VARSGR algorithm within the above-described bank account protection method, all parties involved, the account holder, the financial institution, and the third party (merchant, other financial institution, other individual, and the like, as examples) are thus accorded the greatest degree of reliability that any transactions undertaken through such a method are verified and proper. If a person's account information, personal information, cards, etc., are stolen, any attempts to transact funds transfers pertaining to such accounts would be easily thwarted as the bad actor would not have the ability to timely and/or appropriately access the required verification contact points for the algorithm system request and response protocol. Thus, even with such account information, including passwords (if included) and other possible verification considerations, the lack of algorithm contact points would prevent any processing of such an initiated illegal transaction. Additionally, any attempt at such information gathering through a phishing operation would not only result in a total block of such a transaction, but any further actions by the same bad actor could be easily uncovered as the system can utilize the variable strings to record any communication platforms from such a criminal source and prevent any further transaction attempts from that specific computer, phone, etc., with the same financial institution. In this manner, with the VARSGR financial account protection algorithm system in effect, stolen account information of any type would be worthless.

Furthermore, the ability to, as noted above, modify the required contact points from either the account holder's or the financial institution's profile in relation to a specific account (or sub-account, as the case may be) in any manner, such a regular adjustment on a daily, weekly, bi-weekly, etc., basis, further complicates and thwarts any invasive attempts. In essence, the capability of assigning specific verification contact points that must be not only in receipt of requests from the algorithm system, but also the source of responses back to the algorithm system for each and every transaction in relation to an account, sub-account, etc., initially provides a nearly impregnable barrier to attack by bad actors. The further ability to modify such required verification contact points on demand provides an even higher level of protection, akin to having continuously adjusting combination locks on either side of a transaction door. Since the account holder sets the combination on demand (with, again, the combination being the required verification contact points that must receive and respond to algorithm system requests) on one side (within the above-described algorithm system account holder profile) and the financial institution sets the combination on the other side (through its own algorithm system profile), any modifications made on either side (which, again, do not affect the requirements of the other side) would easily prevent any attempts to hack into the system itself. Any such invasive hacking would not provide any determinative requirements information, initially, let alone the undertaking of such a possible activity would be not only exhausting, but cost prohibitive. Additionally, even if such a situation were to possibly occur, the algorithm system would not have any financial account information, but hard to decipher language which would be worthless to such a bad actor. Likewise, if the financial information were stolen from a financial institution, any attempt to utilize such information would still require accessing the algorithm system verification contact points to allow for any such transaction. Lastly, if the intermediary algorithm system were shut down, the lack of such activity would automatically prevent any transactional processing. In all scenarios, then, the capability of the VARSGR bank account protection method provides, again, the greatest level of security for financial transactions.

The following shows the implementation of such an overarching system to provide continuous and consistent operating system verifications, validations, and protections not only for the benefit of a server in terms of fraudulent user activities, but also for the benefit of a user in terms of protections from a possibly fraudulent computerized device and/or server program (i.e., hacker, virus, and the like).

### DESCRIPTION OF THE DRAWINGS AND PREFERRED EMBODIMENTS

Without any intention of limiting the breadth and scope of the overall inventive method, the following descriptions of the accompanying drawings provide one potentially preferred embodiment of the utilization of the aforementioned inventive algorithm as implemented within a credit card fraud elimination process.

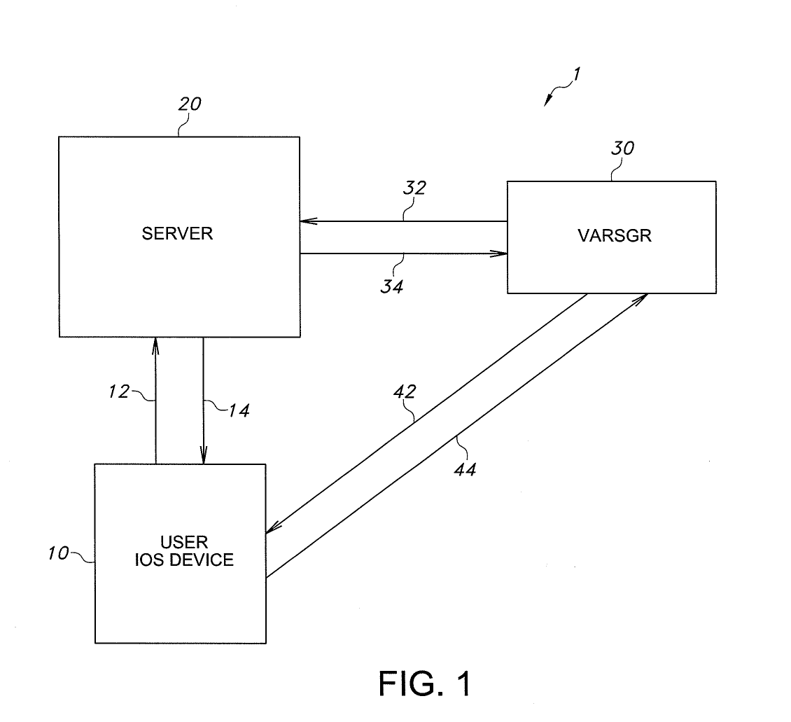

FIG. 1 is a flow chart depicting a monitoring, protecting, and validation protocol method 1 including a representative operating system 10 (computer device, user, etc.) accessing an on-line server 20, with monitoring and verification provided by an intermediary algorithm system (VARSGR) 30. In this situation, as one non-limiting example, the user 10 makes a request (such as, as noted above, a search, a financial transfer, a download, and the like) from the server 20 (such as, again, as non-limiting examples, GOOGLE, AMAZON, YAHOO!, NETFLIX, APPLE, CHASE BANK, and countless other types akin to these, whether as large or even rather small in stature). At that moment, the server 20 notifies 34 the monitor 30 of the initial “device” from which the request is made. Thus, the operating system 10 request 12 to the server 20 includes the contact point of the actual computer device for which the monitor 30 has a generated string on file for that specific purpose. In other words, one the monitor 30 is in place with the server 20, a profile of the device 10 is initiated to generate the string variable that is linked indelibly to the contact point(s) for the device 10 (and thus the operating system itself). Thus, if the request 12 comes from a source other than the proper device 10, the monitor 30 will be able to verify such a situation since the contact point will not properly communicate with the device 10 and/or the contact point(s) associated therewith from the variable string. If the contact point(s) functions properly, then the monitor 30 verifies such a result person, card, etc., and notifies 32 the server 20. Subsequently, the monitor 30 then sends a request 42 to the user 10 seeking contact point verification of the account, bank card, etc., in relation to the user 10 him- or her-self. Once all contact points provide proper send and response 44 in that manner, the monitor 30 notifies the server 20 that such a situation is again, proper. Thirdly, then, the server 20 (which may be a program, device, etc., therein, including a card reader, a downloading program, etc.) is requested by the monitor 30 to provide contact point verifications to ensure the program, etc., on the server is uncorrupted and proper. If, for instance, a card reader is a skimmer or like unauthorized device, the monitor 30 will easily weed out such a result due to a lack of contact point verifications. Likewise, if the program sought for download, again, as an example, is infected with a virus, worm, Trojan horse, etc., the monitor 30 will easily deduce such a result as the activity in that nature would affect the necessary contact point verification result since the program, etc., would not be the same as initiated during variable string generation and application. Thus, this initial 3-step validation method allows for proper monitoring and protection from an overarching perspective, rather than just a single shift protocol as is common throughout the current cybersecurity platforms in utilization today.

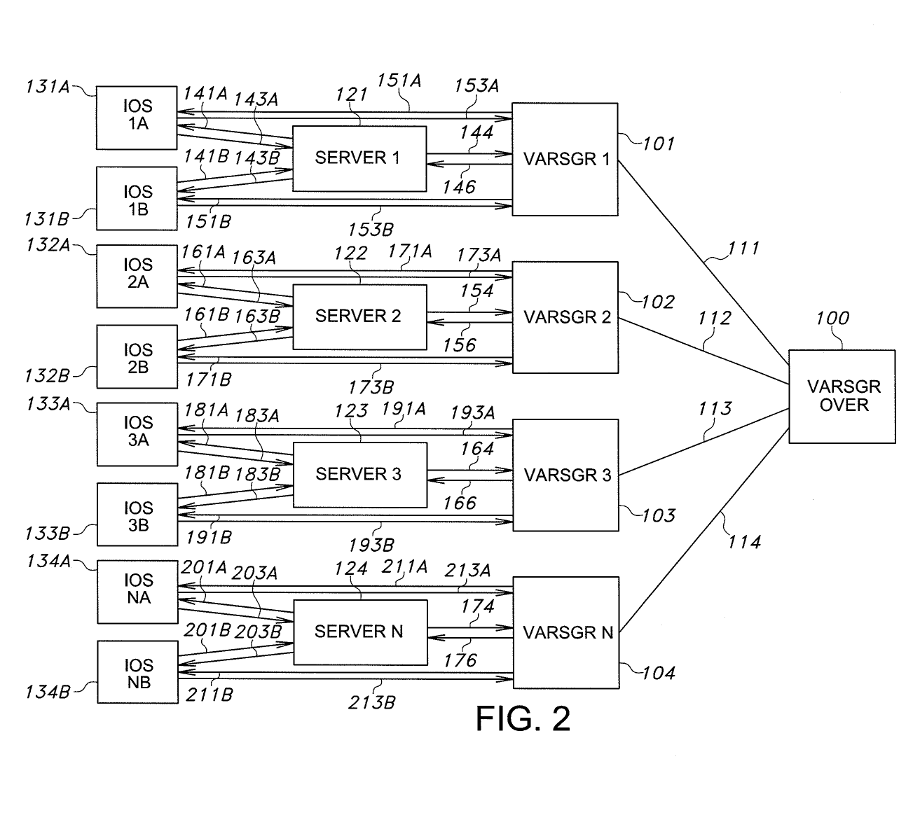

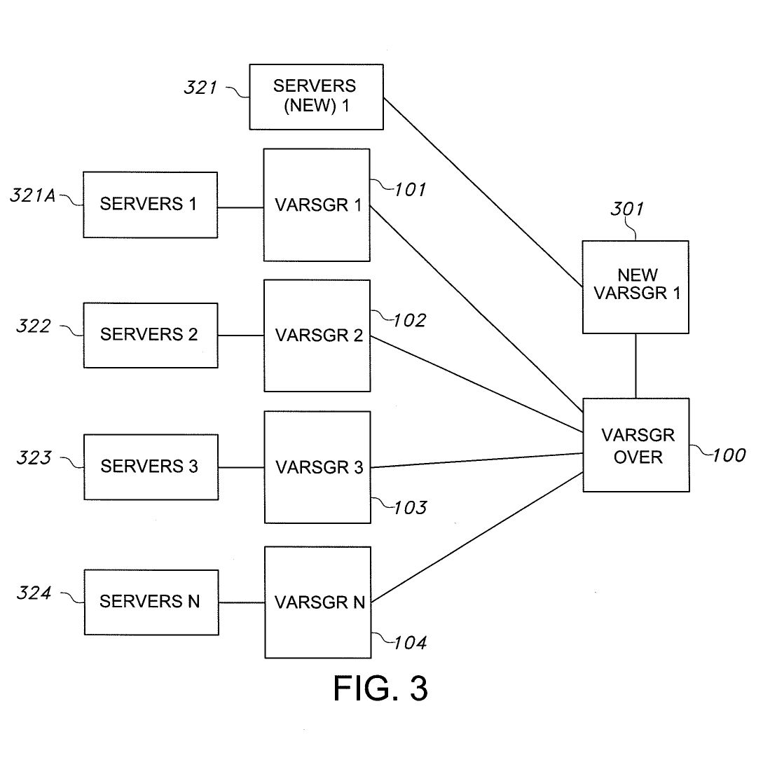

FIG. 2 thus shows the utilization of multiple monitors 101, 102, 103, 104, with the understanding that the label VARSGR N 104 is intended to mean an unlimited number of possible activities in this nature. Thus, the numbers of servers 121, 122, 123, 124, are to be understood in the same manner, with an unlimited number provided. Additionally, multiple servers may be monitored by a single VARSGR program at one time, if desired and/or necessary. Furthermore, then, multiple operating systems 131A, 131B, 132A, 132B, 133A, 133B, 134A, 134B may access the servers 121, 122, 123, 124 in this manner, with, again, the understanding that not only may there be an unlimited number of operating systems involved with unlimited servers, but any number of individual operating systems may access a single server, as well. The same basic monitoring and protecting method as in FIG. 1 is thus accorded for each operating system/server/monitor combination. The server 121, 122, 123, 124 receives a request 141A, 141B, 161A, 161B, 181A, 181B, 201A, 201B (again, of any sort, as described above) from the operating system 131A, 131B, 132A, 132B, 133A, 133B, 134A, 134B, and then the server 121, 122, 123, 124 sends a verification request 144, 154, 164, 174 of the device 131A, 131B, 132A, 132B, 133A, 133B, 134A, 134B to the monitor 101, 102, 103, 104. If verified, the monitor 101, 102, 103, 104, sends a request 151A, 151B, 171A, 171B, 191A, 191B, 211A, 211B to the operating system (user) 131A, 131B, 132A, 132B, 133A, 133B, 134A, 134B, to respond via the same contact point(s) for verification as well. The monitor 101, 102, 103, 104 then requests 146, 156, 166, 176 the server 121, 122, 123, 124 (program, device, etc.) to send a response via its contact point(s) to verify everything prior to completing the requested transaction 143A, 143B, 163A, 163B, 183A, 183B, 203A, 203B with the operating system 131A, 131B, 132A, 132B, 133A, 133B, 134A, 134B. These monitors 101, 102, 103, 104 thus run continuously and consistently to provide nearly instantaneous results in this manner to provide this multiple shift (step) validation to provide overall security to the parties (components) involved along multiple channels and platforms (again, verification of identity, verification of account, verification of device, and even verification of uncorrupted program/download, as examples). Also provided in FIG. 2 is the OVER monitor 100 that provides continuous and consistent monitoring 111, 112, 113, 114 of each of the monitors 101, 102, 103, 104 during operation of the overall monitoring and protection processes for the operating systems 131A, 131B, 132A, 132B, 133A, 133B, 134A, 134B and servers 121, 122, 123, 124. If any problems occur and the monitors 101, 102, 103, 104 provide denials to any of the servers 121, 122, 123, 124 and/or operating systems 131A, 131B, 132A, 132B, 133A, 133B, 134A, 134B, then such is recorded within the OVER monitor 100. FIG. 3 thus shows the further utilization of this OVER monitor 100 to communicate with the monitors 101, 102, 103, 104 as they monitor the servers 321, 322, 323, 324 (and operating systems as in FIG. 2). If, for example, monitor 1 101 in this situation shows a perfect record in terms of confirmations for a server (here SERVERS 1 321A), then the monitor 101 may copy such a server 321A and transition all the information (contact points, etc.) to a new, identical server 321 for monitoring by either the same monitor 101 or a new monitor 301. The “old” server 321A is then provided as a “dangling carrot” for any hackers, viruses, etc., to penetrate. The monitor 101 and/or the OVER monitor 100 can then receive such ineffective intrusion attempts, uncover such hacking, etc., activity and actually react in such a way as to discover the intrusion, etc., source and even, potentially, unleash its own program(s) to attack such a problem. Thus, the OVER monitor 100 allows for the complete monitoring of the monitors 101, 102, 103, 104, 301, in this situation, as well as provide the potential to not only block such intrusions, but combat such attempts through an offensive posture and activity. This OVER monitor 100 may also be permitted direct monitoring itself of servers 321, 322, 323, 324, 321A if desired, and multiple OVER monitors 100 may be employed if desired for such a purpose as well, even with overlapping monitoring and communication of individual monitors 101, 102, 103, 104, 301 if such is desired. Furthermore, multiple monitors 101, 102, 103, 104, 301 may be utilized in sequence or permutation, again, if desired, to accord even greater degrees of not only validation and verification potentials, but also to defend against any other hacking attempts to a stronger level. As noted above, the ability to even flip tables in relation to variable strings at the monitor (VARSGR) level can be further expanded upon as each of the monitors themselves may be provided in a manner that allows for transfer and “flipping” to different locations and sources, thereby creating increased difficulties in pinpointing exact VARSGR presence in relation to any specific operating system, server, or other monitored program, etc.

Such accompanying drawings thus show the base flow charts of the operating system monitoring and protection system implemented through the utilization of the inventive string variable algorithm. Certainly, although these are broadly presented, it should be evident that the devices, programs, users, accounts, etc., involved may be of any type associated with a request (or any type of transactional capability) with a computer server of any type (whether it be an email being sent, a search engine request, access to a web site, utilization of a credit card on-line, accessing a social media platform, etc., the type of action in this respect is basically without limit). As long as the profile(s) set up with each device, user, program, account, etc., provide the necessary verification contact points, the algorithm system verifies such points in relation to the operating system, and the communications and responses are sent to and from the necessary contact points in relation to each request, whether in terms of the user, the server, or the device involved, then the system is properly in place and utilized. As well, such profiles may be properly adjusted in terms of the verification contact points required of specific types of requests (such as search request as compared with financial account usage, as examples). If such modifications to contact point requirements are made subsequent to profile creation (and thus after the subject profile is set-up between the VARSGR and the operating system, at least), then such changes will automatically require response to requests from the intermediary algorithm system of each contact point within both profiles in order to ensure verification of such a modification. Furthermore, there is basically no limit to the scalability, capability, or utility of this overall system requiring the VARSGR algorithm in order to provide effective communication and verification of operating systems (as well as protections from hacking, viruses, and the like) is intended with the descriptions and depictions herein, either.

Thus, the preceding examples are set forth to illustrate the principles of the invention, and specific embodiments of operation of the invention. The examples are not intended to limit the scope of the method. Additional embodiments and advantages within the scope of the claimed invention will be apparent to one of ordinary skill in the art.

What is claimed is:

1. A computerized method for substantially monitoring operating systems and servers concurrently for verification of device identifications, user identifications, and server program validity, said method including the utilization of an intermediary algorithm system for electronic communication with said device and said server program, wherein said intermediary algorithm communicates with said device and said server through established contact points generated through a variable string wherein verification of identity and status of said device and said server are provided upon reply of a request from said intermediary algorithm system to both said device and said server through a specific contact point, wherein said verification is determined upon receipt of a timely reply form said device and said server through the same contact point from which each separate request is made.

2. The method of claim 1 wherein said method includes the steps of:
1) generation of a computer device profile within said intermediary algorithm system, wherein said device profile includes verification contact point requirements to be undertaken by said intermediary algorithm system upon utilization of said device within a request or transaction with said server, and wherein no other information pertaining to said device is shared with or otherwise stored within said intermediary algorithm system;
2) generation of a computer server profile within said intermediary algorithm system, wherein said server profile includes verification contact point requirements to be undertaken by said intermediary algorithm system upon utilization of said device within a request from or transaction with an operating system, and wherein no other information pertaining to said server is shared with or otherwise stored within said intermediary algorithm system;
3) establishing specific contact point identifications with said intermediary algorithm system through an initial communication with each required verification contact point within both profiles of said device and said server, wherein each of said specific contact point identifications are defined by unique string variables generated by said intermediary algorithm system;
4) initiating a request or transaction by said device to said server;
5) requesting verification of the identity of said device by said server through communication with said intermediary algorithm system prior to completion of said request or transaction;
6) undertaking communication between said intermediary algorithm system and the required verification contact points associated with said device such that substantially instantaneous determination of verification is accomplished through the reception of proper signals from said verification contact points by said intermediary algorithm system in response to requests sent from said system to each of said required verification contact points for that specific transaction, such that if the proper signals from all such required contact points are received then said intermediary algorithm system determines the device is authentic for such a transaction and if any signals are determined improper, then said intermediary algorithm system determines said device is not authentic for such a transaction; and
7) transferring the results of step “6” from said intermediary algorithm system to each said server;
wherein said intermediary algorithm system provides verification notifications and responses to said server without any required human interaction;
wherein said results transfer step of “7” is undertaken without the need for any input or disclosure of any personal information of said device to said server; and
wherein said method is undertaken through the utilization of at least one computer program within a non-transitory medium.

2. The method of claim 1 wherein said device profile includes more than one verification contact point requirement per each account transaction.

3. The method of claim 2 wherein said server profile includes more than one verification contact point requirement per each account transaction.

4. The method of claim 2 wherein modification of the number and level of verification contact points requirements per transaction within said device's profile subsequent to initial intermediary algorithm system profile set-up.

5. The method of claim 4 wherein said modification of the number and level of verification contact points requirements per transaction within said server's profile subsequent to initial intermediary algorithm system profile set-up.
